(19) United States
(12) Patent Application Publication
(10) Pub. No.: US 2006/0187822 A1
(43) Pub. Date: Aug. 24, 2006

(54) Method and apparatus for partitioning allocation and management of jitter buffer memory for tdm circuit emulation applications

(76) Inventor: Zohar Peleg, Rosh Haain (IL)

Correspondence Address: Mark Friedman;Bill Polkinghorn, 9003 Florin Way, Upper Marlboro, MD, 20772, US

(21) Appl. No.: 10/549,678

(22) PCT Filed: Jun. 29, 2004
(86) PCT No.: PCT/IL04/00575

§ 371 Date: Sep. 19, 2005

Related U.S. Application Data
(60) Provisional application No. 60/484,294, filed on Jul. 3, 2003.

(51) Int. Cl. H04L 12/26; H04L 12/56; H04L 12/28

(52) U.S. Cl. 370/229; 370/412; 370/394

(57) ABSTRACT

A method for partitioning allocation and management of a jitter buffer memory for TDM circuit emulation applications comprises the steps of obtaining a channel hierarchy for a plurality of packet carrying channels having different channel rates, obtaining a packet sequential number, and using the channel hierarchy and the packet sequential number, generating a base-address in the jitter buffer memory. Each channel is allocated a space in the buffer memory that is proportional to its rate, and out-of-order packets are automatically reordered by the jitter buffer.

### FIELD AND BACKGROUND OF THE INVENTION

The present invention relates generally to the field of transmission of timing-sensitive synchronous data over asynchronous media, and in particular to the transmission of time division multiplexed (TDM) circuits over packet-switched networks (PSNs). More particularly, the present invention relates to jitter buffers, which are key components in the reception of TDM payloads transmitted over a PSN. A jitter buffer is a device that supports a smooth play-out of synchronous, timing-sensitive data (e.g. audio, video, or TDM circuits) in cases where the data is received with jitter, due to propagation through asynchronous media such as PSNs.

Emulation of a TDM circuit is done by sampling the TDM traffic and by de-multiplexing it into distinct channels. The data stream of each channel is sliced into fragments. Each fragment is encapsulated within a set of network headers to form a packet and is transmitted over the packet network. Each TDM data fragment constitutes a payload of one packet. The TDM circuit is reconstructed at the receiving end by extracting the packet payload, reassembling the channel data stream, and multiplexing the multiple channels data into a single TDM circuit. The delay between transmission and reception may vary from packet to packet. The variation in delay is referred to as “jitter”. When the jitter is larger than the original time-interval between consecutive packets, packets may arrive out-of-sequence. Since the data must be played-out at the same rate and in the same order as the data sampled, the jitter must be removed and packets must be reordered before play-out. The jitter removal and packet reorder are done by the jitter buffer.

### SUMMARY OF THE INVENTION

The present invention is of a method and apparatus for partitioning allocation and management of jitter buffer memory that supports multiple channels of TDM circuit emulation over packet networks, where each channel can run at a different bit rate and a different packet rate.

According to the present invention there is provided a method for partitioning allocation and management of jitter buffer memory for TDM circuit emulation applications comprising the steps of obtaining a channel hierarchy for a plurality of packet carrying channels having different channel rates, obtaining a packet sequential number and generating a base-address in the jitter buffer memory using the channel hierarchy and the packet sequential number, whereby the partitioning allocation and management of the jitter buffer memory is correlated with the generated segment base-address such that each channel is allocated a space in a buffer memory of a given size, the space being proportional to a respective said channel rate, and whereby out-of-order packets are automatically reordered by the jitter buffer.

According to the present invention there is provided a hierarchically partitioned jitter buffer memory comprising a plurality of hierarchically arranged queues correlated with a channel hierarchy, and a mechanism for addressing the hierarchically arranged queues.

According to the present invention there is provided a method for partitioning allocation and management of jitter buffer memory for TDM circuit emulation applications comprising the steps of: obtaining a channel hierarchy for a plurality of packet carrying channels having different channel rates, dividing the jitter buffer memory into a plurality of hierarchically arranged queues, and allocating each hierarchically arranged queue to a respective channel so that the queue hierarchy follows the channel hierarchy, whereby the jitter buffer memory can be advantageously optimized for TDM emulation by a hierarchical partitioning that follows the SONET/SDH hierarchy.

### BRIEF DESCRIPTION OF THE DRAWINGS

The invention is herein described, by way of example only, with reference to the accompanying drawings, wherein:

FIG. 1 shows the structure of a jitter buffer according to the present invention;

FIG. 2 shows an example of a possible OC-12 topology tree, which comprises a mixture of STS-3c, STS-1, VT-1.5 and VT-2 channels;

FIG. 3 shows an exemplary memory partitioning for the channel-tree hierarchy example shown in FIG. 2 according to the present invention;

FIG. 4 shows a flow chart of the main steps of the method for partitioning allocation and management of the jitter buffer memory according to the present invention;

FIG. 5 shows a framework for the jitter buffer management process that includes the inventive partitioning allocation and management of the jitter buffer memory described in FIG. 4;

FIG. 6 shows a flow chart of the base-address generation according to the present invention.

### DESCRIPTION OF THE PREFERRED EMBODIMENTS

The present invention is of a method and apparatus for partitioning allocation and management of jitter buffer memory for TDM circuit emulation applications.

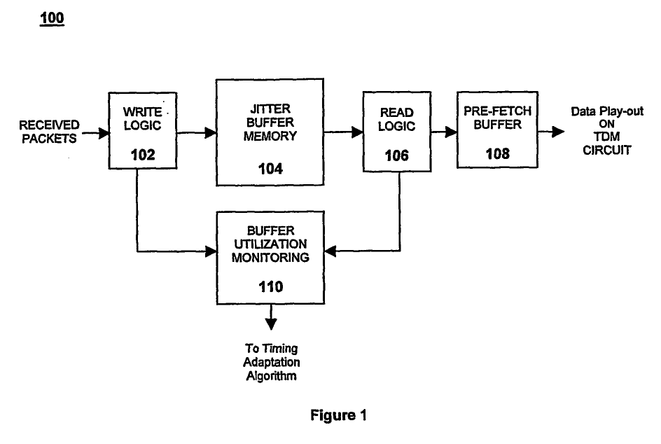

FIG. 1 shows the structure of a jitter buffer 100 according to the present invention.

Jitter buffer 100 comprises a write logic block 102, a memory 104, a read logic 106, a pre-fetch buffer 108 and a buffer utilization (BU) monitoring unit 110. Memory 104 is the core element of the jitter buffer and is used for storing the received payload. It may be any type of memory, for example SRAM, DRAM, SDRAM, RDRAM, etc., configurable in size from 256 KB to 32 MB, and operative to handle a compressed payload with a variable packet length (the variable length being the result of the compression). A main inventive feature of the jitter buffer memory according to the present invention is its capability to be optimized for TDM emulation by a hierarchical partitioning that follows the SONET/SDH hierarchy. The stored data is sorted into channels, where the data of each channel is ordered sequentially. That is, the sorted data is stored in the order in which it was transmitted, which is not necessarily the order in which it was received. For example, suppose packets 1-2-3 were transmitted in this sequence but received in a sequence 1-3-2. According to the present invention, when packet 3 is received it is not stored right after packet 1, but leaves an empty space for packet 2. When packet 2 is received it is not stored after packet 3, but rather stored in the empty space saved for it between packets 1 and 3.

Write logic 102 receives a packet, detects the destination circuit, verifies that the packet is within the desired, programmable time window, and generates a write address in order to place the packet in the right order within the right channel queue. Then it stores the packet payload sequentially into this memory location (i.e. the range of addresses starting at a base-address, explained in more detail below). While the TDM data needs to be played out one-byte at a time in accurate timing, the jitter buffer memory is accessed with long bursts and wider data paths, and requires large arbitration and access time relative to the play-out timing granularity. Pre-fetch buffer 108 is designed to guarantee consistent data flows, while compensating for the differences between the memory access and data play-out. Pre-fetch buffer 108 includes a small temporary buffer per-channel (not shown) with allocated size, which is proportional to the respective channel's rate. The temporary buffer is filled by reading multiple words of data from the jitter-buffer memory using burst-read access, and dispenses single bytes into the TDM stream in the right time-slots. The pre-fetch buffer is designed to start fetching early enough, before the buffer empties or drains-out, and to fetch and hold enough data so that the TDM play-out is never starved.

Read logic 106 performs the read access as requested by the pre-fetch buffer, while tracking the read pointer of each channel. Buffer utilization monitoring unit 110 holds a buffer-utilization counter per channel, which provides the instantaneous number of bytes stored in the queue at any given moment. The BU monitoring unit monitors the amount of buffered data in each channel, by adding the amount of data that is written into the buffer and by subtracting the amount of data played-out of the buffer.

Each channel can be in either one of two jitter-buffer states: “fill” or “normal”. In the “fill” state data is written to the buffer but there is no TDM data play-out. The buffer utilization is monotonously increasing. When the channel reaches its pre-determined operating point (OP), it moves into a “normal” state, in which the data is read from the jitter-buffer queue and played-out on the TDM circuit. The OP is a programmable depth of the jitter buffer. As long as the play-out rate is synchronized with the sampling rate at the transmitting end, the average utilization remains balanced around the OP. If the transmission is disrupted for a period long enough to drain the buffer, the buffer empties and returns to the “fill” state.

TDM Channel Hierarchy

In order to better understand the method of the present invention, reference is first made to the normal way (in prior art) of optimizing the jitter buffer structure for storing channelized SONET circuit payloads. In SONET, the OC-12 circuit hierarchy comprises the following circuit levels: STS-12, STS-3, STS-1 and VTG and VT. Each STS-12 contains 4 STS-3 circuits. Each STS-3 contains 3 STS-1 circuits (total of up to 12 STS-1 circuits in OC-12). Each STS-1 circuit contains 7 VTG circuits (total of up to 84 VTG circuits in OC-12). Each VTG circuit contains 4 VT-1.5 circuits or 3 VT-2 circuits (total of up to 336 VT-1.5 circuits or 252 VT-2 circuits in OC-12).

The SONET/SDH traffic may carry any mixture of the circuit levels. Going through circuit emulation over a PSN, this traffic may be distributed into distinct channels, where each channel is packetized and transmitted as a separate packet-flow over the PSN. Some flexibility is provided in mapping of the TDM circuit structure into the PSN channel structure, since some channelized payload structures allow the choice of either mapping the circuit into a single channel or breaking it down to multiple lower-rate channels. Table 1 shows various options for mapping TDM circuits into PSN channels.

TABLE 2
Circuit to PSN-channel mapping options - Structured Mode

| SONET Circuit | SDH Circuit | Possible PSN channels |
|---|---|---|
| Non-channelized STS-1 | VC-3 | STS-1/VC-3 |
| SPE | | |
| Channelized STS-1 SPE | VC-3 | STS-1/VC-3 |
| | | Fractional STS-1/VC-3 |
| | | VT-1.5/VC-11 |
| | | VT-2/VC-12 |
| STS-3c SPE | Non-channelized | STS-3C/VC-4 |
| | VC-4 | |
| Channelized STS-3 | STM-1 | STS-1/VC-3 |
| | | VT-1.5/VC-11 |
| | | VT-2/VC-12 |
| (No SONET Equivalent) | Channelized | Fractional VC-4 |
| | VC-4 | VC-3, fractional VC-3 |
| | | VT-1.5/VC-11 |
| | | VT-2/VC-12 |
| STS-12c-SPE | VC-4-4c | STS-12c/VC-4-4c |
| Channelized STS-12 | STM-4 | STS-3c/VC-4 |
| | | STS-1/VC-3 |
| | | VT-1.5/VC-11 |
| | | VT-2/VC-12 |

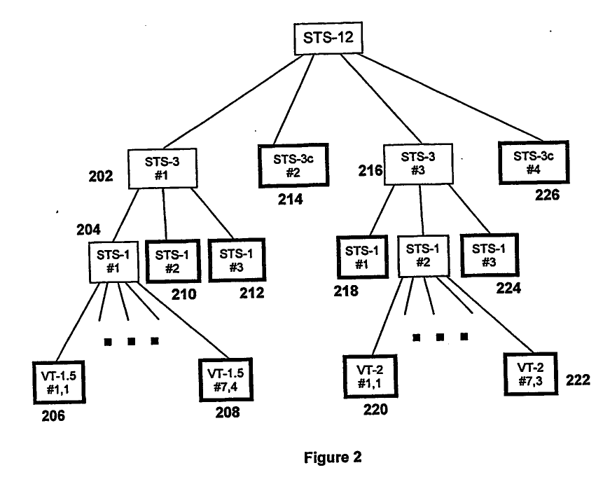

FIG. 2 shows an example of a possible OC-12 topology tree (prior art), which comprises a mixture of STS-3c, STS-1, VT-1.5 and VT-2 channels. According to one aspect of the present invention, the tree configuration or topology is a set of configurable stop flags, which is used to select any subset of this tree by selecting the level of the leaf-node on each branch. The tree-creation is used as an input to the method of the present invention, and other tree topologies may be used for the same purpose. A stop-flag per node determines that the corresponding node becomes a leaf (as long as the branch is not stopped at a higher level). Any node that resides below a leaf node would be trimmed-off and excluded from the selected tree, and the corresponding payload would remain multiplexed within the channel marked by the remaining leaf-node. Each incoming packet is uniquely identified and associated with the corresponding channel, allowing multiple channels, carried over multiple packet flows, to be multiplexed into a single TDM stream.
Channel Naming Convention (Prior Art)

Each node on the channel-tree has a unique name (designation) of the form {Type (J. K, L, M)}. J designates the STS-3/VC-4 number (1 to 4) within the STS-12/STM-4 level. K designates the STS-1/TUG-3 or VC-3 number (1 to 3) within the STS-3/VC-4 level. L designates the VT-Group/TUG-2 number (1 to 7) within the STS-1/TUG-3 level. M designates the VT-2/TU-12 number (1 to 3) or the VT-1.5/TU-11 number (1 to 4) within the VT-group/TUG-2 level. A zero value indicates that the corresponding level is below the stop-level and therefore outside the selected tree. Using this convention, the following channels are defined in the example shown in FIG. 2:

1. The first STS-3 circuit 204 is divided as follows: STS-1 circuit #1 (202) is broken into 28 VT-1.5 channels, named VT1.5(1,1,1,1) 206, VT1.5(1,1,1,2), . . . , VT1.5(1,1,7,4) 208. STS-1 circuit #2 210 and STS-1 circuit #3 212 are designated as channels, named STS1(1,2,0,0) and STS1(1,3,0,0).

2. The second STS-3 circuit 214 is designated as a STS-3c channel, named STS3(2,0,0,0).

3. The third STS-3 circuit 216 is divided as follows: the first STS-1 circuit 218 and the third STS-1 circuit 224 are designated as channels named STS1(3,1,0,0) and STS1(3,3,00) respectively. The second STS-1 circuit is divided into 21 VT-2 channels named VT2(3,2,1,1) 220, . . . , VT2(3,2,7,3) 222.

4. The fourth STS-3 circuit 226 is designated as a STS-3c channel, named STS3(4,0,0,0).

Buffer Partitioning and Memory Allocation

According to the present invention, the jitter buffer memory is hierarchically divided into queues, where each queue is allocated to one channel. A queue is a memory space designated for buffering the packet stream of one channel. The queue hierarchy follows the channel hierarchy, with the exception that the partitioning into queues is done preferably by using powers of 2 division factors, to maintain an easy addressing scheme. For example, while there are three STS-1s in one STS-3, the STS-3 memory area is divided into four STS-1 queues, of which three are used by the three STS-1 channels and one remains unused, see below. When the jitter buffer memory is entirely allocated to a channelized STS-12 circuit, the jitter buffer memory is partitioned as follows: the entire memory may be used for one STS-12 channel, or further divided into four sections, where each section is designated for one STS-3 channel. Each STS-3 memory section may be entirely used for one STS-3 channel or further divided into four equal STS-1 sections, out of which three are in use and one is reserved. Each STS-1 memory section can be used for one STS-1 channel, or further divided into eight equal VTG sections, out of which seven are in use and one is reserved. Each VTG section is further divided into four VT-1.5 sections, out of which three are in use and one is reserved.

As a result, the memory hierarchy (as opposed to the actual circuit hierarchy) is divided into 512 VT-1.5 sections (out of which 336 are in use), up to 16 STS-1 sections out of which 12 are in use, or up to 4 STS-3 sections or a single STS-12 section.

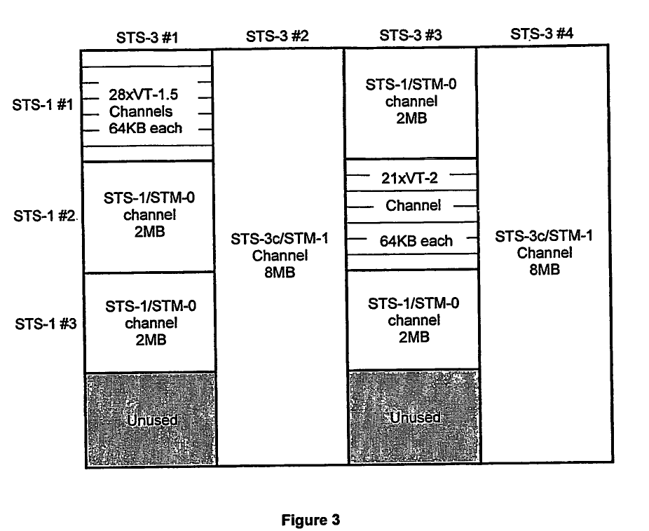

FIG. 3 shows an exemplary memory partitioning for the channel-tree hierarchy example shown in FIG. 2. As mentioned, a queue is a memory space designated for buffering the packet stream of one channel. Each queue is further divided into segments, where the number of segments and the size of each segment in bytes are both integer powers of 2 (i.e. 2ⁿ where n is an integer number). Each segment is designed to hold one and only one packet, and therefore the size of the segment is determined to be the minimum integer power of 2 that can hold the maximum packet size for the channel. Once the segment size is determined, the number of segments is determined as well, given a predetermined queue size.

For example, a 8 MB memory is allocated to a channelized STS-3 circuit and the third STS-1 circuit is further divided into 28 VT-1.5 channels, each with a packet-payload size of 27 bytes. The queue allocation is therefore a 2 MB queue for each STS-1 channel (¼ of 8 MB), and 64 KB for each VT-1.5 channel ( 1/32 of 2 MB). Due to this partition, the maximum queue size is roughly proportional to the rate of the channel and the buffering capability is distributed evenly between channels of different rates, as demonstrated in the following.

Using the partitioning in the example above, the STS-1 channel segment size is 1024 bytes, which is the minimum integer power of 2 required for holding 783 bytes, and therefore there are 2048 segments. The VT-1.5 segment size is 32 bytes, and therefore the number of segments per queue is also 2048 segments. Given that each packet in this example is holding one frame, which is a time-equivalent data of 125 μs, the 2048 segments of either channel type can provide up to 256 ms of buffering time.

Each channel may be independently configured for using any portion of the allocated maximum buffering time by selecting the buffer depth from that of one packet to that of a full queue size. Each arriving packet is uniquely associated with a unique channel identification (“channel ID” or “CH-ID”) and, in an exemplary case, a 14-bit sequential number. Inventively, a 1:1 address mapping scheme is used to provide each arriving packet with a pre-allocated segment as follows: the queue base-address is a 1:1 mapping of the channel identification number, and the segment base-address is a 1:1 mapping of the packet sequential number. This allocation method guarantees efficient and fast addressing and provides automatic reordering, since each arriving packet is stored in the right segment, regardless of its arrival order.

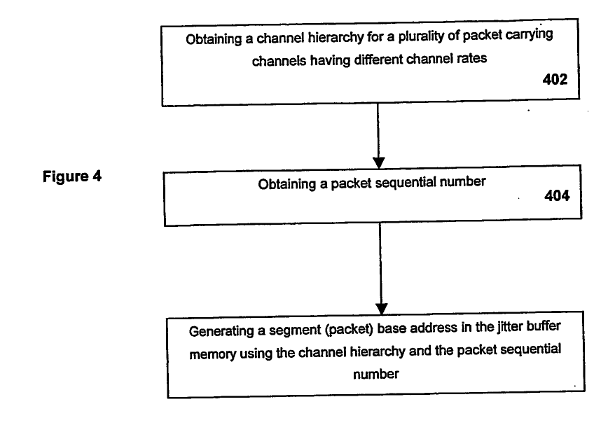

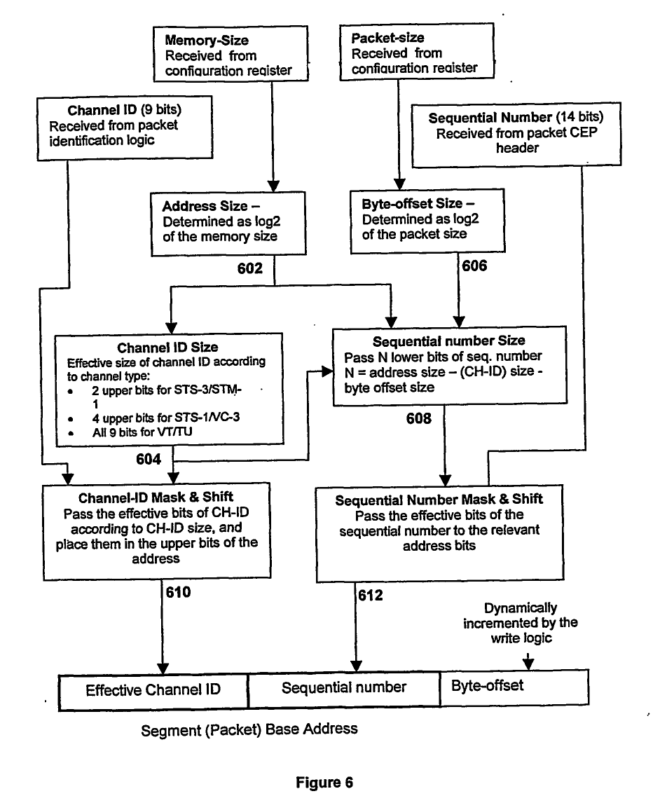

The method for partitioning allocation and management of the jitter buffer memory described above is summarized in the flow chart of FIG. 4. In the most basic terms, the method comprises three steps: step 402 for obtaining a channel hierarchy for a plurality of packet carrying channels having different channel rates, step 404 for obtaining a packet sequential number, and step 406 for generating a segment base-address in the jitter buffer memory using the channel hierarchy and the packet sequential number. Each channel is thus allocated a space in the buffer memory that is proportional to the rate of the channel, out-of-order packets being automatically reordered by the jitter buffer. Step 406 (which is explained in more detail with reference to FIG. 6) results in the division of the buffer memory into a plurality of hierarchically arranged queues and in the allocation of each queue to one channel, so that the queue hierarchy follows the channel hierarchy.

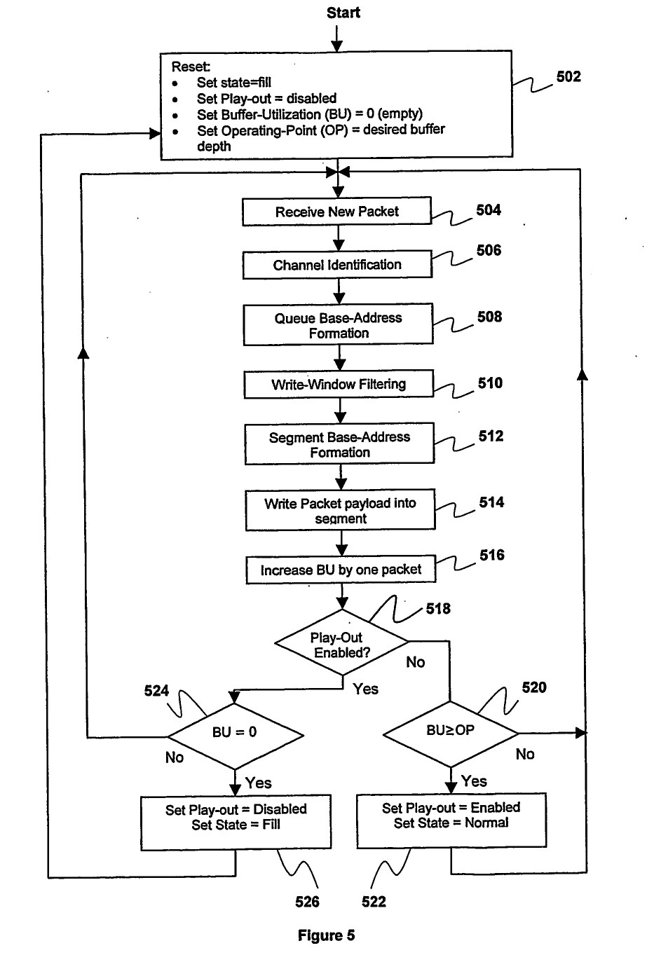

FIG. 5 shows a framework for the jitter buffer management process that includes the inventive steps of partitioning allocation and management of the jitter buffer memory described in FIG. 4. Upon an initialization step 502, the jitter buffer is set into a “fill” state, and the buffer utilization counter is set to 0. When a new packet is received in step 504, a circuit-multiplexing label in the packet header (also referred to as a “circuit emulation over packet” or “CEP” header) is used to associate each received packet with the corresponding channel. Once the channel is identified in step 506, the queue base-address is automatically determined (formed) in step 508. The jitter-buffer write logic keeps track of the allowed write-window per channel, which is a sliding window of sequential numbers that start one packet above the presently read packet and end at the maximum queue size above the presently read packet. The sequential number of each received packet is filtered by the allowed write-window in step 510. Packets that do not fit in the window are dropped. The window size can be further limited below the physical size of the memory allocated for the queue in order to increase the filtering of stale or bad packets. If the packet fits in the write-window, the segment base-address is determined as a function of the sequential number in step 512, and the packet is written into the corresponding queue in step 514. The BU counter is incremented in step 516. A “playout-enable” condition is tested in step 518, to reveal if the buffer is in the fill state or in the normal state. “Yes” means play-out enabled and “No” means not play-out enabled. While in the fill state, queued packets are accumulated and not played out until the buffer utilization reaches the programmable operating point (OP) in step 520. Step 520 checks the condition BU≧OP, i.e. whether buffer utilization has reached or exceeded the operating point. Once the buffer utilization reaches the operating point in step 522 (“Yes” in step 520) the jitter buffer state is set to “normal”, and the jitter buffer starts playing out the queued data, up to one byte per cycle. If No, the process goes back to step 504 without state changes. The packet payload residing in multiple queues is multiplexing into a single TDM byte stream by alternately playing bytes from different queues, according to the hierarchical topology of the various channels. If at any time the buffer runs out of data due to discontinued transmission or network disruptions, and if the buffer utilization drops to 0 (“Yes” in step 524), the buffer state is set back to “fill” (step 526) and the data accumulation starts over. If “No” in step 524 the process returns to step 504.

Note that steps 506-512 are equivalent to steps 402-406 in FIG. 4. The queue base-address formation in step 508 essentially results from the action taken in step 402, while steps 512 and 406 are essentially equivalent.

Address Generation

The address generation is the means to obtain the memory partition and management, as it causes each data item to be written in the designated location as determined by the policy embedded in the method of the present invention. The address comprises an inventive base-address and a byte-offset. The inventive base-address generation (i.e. step 406 in FIG. 4) is described schematically in the flow chart of FIG. 6 and comprises preferably the following:

1. Determining the number of address bits as a log2 of the total memory size in step 602. In the following examples shown in Tables 2, 3, and 4, a 25-bit address is selected for supporting a 32 MB memory.

2. Determining in step 604 the upper 2, 4 or 9 bits using the channel identification number (CH-ID) for STS-3, STS-1 or VT channels respectively: 2 bits if the channel is STS-3, 4 bits if the channel is STS-1, or 9 bits if the channel is VT.

3. Determining the number of lowermost bits allocated for the byte offset as the log 2 of the selected packet size in step 606.

4. Determining the number of bits to be copied from the lower side of the packet sequential number as the remaining bits (in the middle section of the address word), after subtracting the byte-offset bits and the CH-ID bits from the total address size in step 608.

5. Selecting in step 610 the effective CH-ID bits from the input CH-ID, by masking the irrelevant bits and by shifting the remaining bits to the right location in the address given by the left-most 2, 4, or 9 bits as determined by step 604, starting at the highest bit location as determined by step 602.

6. Selecting in step 612 the effective part of the sequential number, by masking out the irrelevant bits and by shifting the remaining bits to the right location in the address word that is immediately adjacent to the CH-ID bits.

Table 2 shows a few examples of address generation corresponding to several channel types with different packet sizes, assuming a 32 MB memory divided into various queue types as shown in FIG. 3.

TABLE 3

| Ch. | Channel Type | | | | | | | | | | | | | | | | | | | | | | | | | |
|---|---|---|---|---|---|---|---|---|---|---|---|---|---|---|---|---|---|---|---|---|---|---|---|---|---|---|
| # | (Payload Size) | 24 | 23 | 22 | 21 | 20 | 19 | 18 | 17 | 16 | 15 | 14 | 13 | 12 | 11 | 10 | 9 | 8 | 7 | 6 | 5 | 4 | 3 | 2 | 1 | 0 |

| 1 | STS-12c (783) | Sequential Number | | | Byte offset |
|---|---|---|---|---|---|
| 2 | STS-3c (783) | STS3# | Sequential Number | | Byte offset |
| 3 | STS-1 (783) | STS3# | STS1# | Sequential Number | Byte offset |

| | | | | | |
|---|---|---|---|---|---|
| 4 | STS-1 (261) | STS3# | STS1# | Sequential Number | Byte offset |

| | | | | | | | |
|---|---|---|---|---|---|---|---|
| 5 | VT-1.5 (27) | STS3# | STS1# | VTG# | VT# | Sequential Number | Byte offset |

In the following example, the memory allocation for STS-3c channel #2 (214 in FIG. 2) identified by (2,0,0,0) is done as follows: the queue is 8 MB from address 0x800000 to address 0xFFFFFF. Bits 24-23 have a fixed value of 01 for this queue, and the remaining 23 bits are divided between the segment address and the byte offset as follows: the packet size is 783 bytes (⅓ frame), and therefore the packet segment is 1024 bytes. The lower 10 bits are therefore the byte offset within the packet segment, and the remaining 13 bits (22-10) are used as a segment address, determined by the 13 lower bits of the packet sequential number. The resulting address is

TABLE 3

| 24-23 | 22-10 | 9-0 |
|---|---|---|
| 01 | Lower 13 bits of sequential | Byte offset within packet- |
| | number | payload |

In the following example in Table 4, the VT-1.5 channel is identified as 3-2-5-4 (STS-3 #3, STS-1 #2, VTG #5, VT-1.5 #4). The queue is 64 KB (65536 bytes) at base-address 0x1330000, allowing up to 2048 segments of 32-bytes each. The resulting address is:

TABLE 5

| 24-23 | 22-21 | 20-18 | 17-16 | 15-5 | 4-0 |
|---|---|---|---|---|---|
| 10 | 01 | 100 | 11 | Lower 11 bits of | Byte offset |
| | | | | sequential number | |

While the invention has been described with respect to a limited number of embodiments, it will be appreciated that many variations, modifications and other applications of the invention may be made.

What is claimed is

1. A method for partitioning allocation and management of jitter buffer memory for TDM circuit emulation applications comprising the steps of:
a. obtaining a channel hierarchy for a plurality of packet carrying channels having different channel rates;
b. obtaining for each packet a respective packet sequential number; and
c. generating a segment base-address in the jitter buffer memory using said channel hierarchy and said respective packet sequential number;
whereby said partitioning allocation and management of the jitter buffer memory is correlated with said generated segment base-address such that each said channel is allocated a space in a buffer memory of a given size, said space being proportional to a respective said channel rate, and whereby out-of-order packets are automatically reordered by the jitter buffer.

2. The method of claim 1, wherein said step of obtaining a channel hierarchy includes obtaining a channel hierarchy for at least two of channels of said plurality that include packets of different size.

3. The method of claim 2, wherein said step of obtaining a channel hierarchy further includes obtaining a channel identification (CH-ID) number.

4. The method of claim 3, wherein said obtaining of a CH-ID number includes obtaining a CH-ID number of 9 bits.

5. The method of claim 4, wherein each said packet includes a CEP header, and wherein said step of obtaining a packet sequential number includes obtaining a 14 bit sequential number from said CEP header.

6. The method of claim 3, wherein said generating a segment base-address in the jitter buffer memory includes dividing said jitter buffer memory into a plurality of hierarchically arranged queues and allocating each said queue to one said channel, so that the queue hierarchy follows said channel hierarchy

7. The method of claim 6, wherein said step of generating a segment base-address includes determining an address size based on said jitter buffer memory size.

8. The method of claim 7, wherein said determining an address size based on said jitter buffer memory size further includes:
i. determining a number of address bits as a log2 of said jitter buffer memory size,
ii. determining a number M of upper bits for a respective channel using said CH-ID number
ii. determining a byte-offset size that includes a number N of lowermost bits allocated for a byte offset,
iv. determining a number P of remaining bits from said packet sequential number,
v. selecting a number of effective channel identification bits from said CH-ID, and
vi. selecting an effective part of said packet sequential number.

9. The method of claim 6, wherein said dividing said jitter buffer memory into a plurality of hierarchically arranged queues includes partitioning said jitter buffer memory into said queues by using powers of 2 division factors.

10. A hierarchically partitioned jitter buffer memory comprising:
a. a plurality of hierarchically arranged queues correlated with a channel hierarchy; and
b. a mechanism for addressing said hierarchically arranged queues.

11. The jitter buffer memory of claim 10, wherein said hierarchically arranged queues are further divided into segments, each said segment designed to hold one packet.

12. The jitter buffer memory of claim 11, wherein each of said segments is characterized by a size in bytes correlated with a maximum packet size carried by a respective said channel.

13. The jitter buffer memory of claim 11, wherein the number of said segments in bytes is an integer power of 2.

14. The jitter buffer memory of claim 13, wherein said segment size is the minimum integer power of 2 that can hold said maximum packet size.

15. A method for partitioning allocation and management of jitter buffer memory for TDM circuit emulation applications comprising the steps of:
a. obtaining a channel hierarchy for a plurality of packet carrying channels having different channel rates;
b. dividing the jitter buffer memory into a plurality of hierarchically arranged queues; and
c. allocating each said hierarchically arranged queue to a respective said channel so that said queue hierarchy follows said channel hierarchy;
whereby the jitter buffer memory can be advantageously optimized for TDM emulation by a hierarchical partitioning that follows the SONET/SDH hierarchy.

16. The method of claim 15, wherein said step of obtaining a channel hierarchy includes obtaining a channel hierarchy for at least two of channels of said plurality that include packets of different size.

17. The method of claim 16, wherein said step of obtaining a channel hierarchy further includes obtaining a channel identification (CH-ED) number.

18. The method of claim 17, wherein said obtaining of a CH-ID number includes obtaining a CH-ID number of 9 bits.

19. The method of claim 15, wherein said dividing the jitter buffer memory into a plurality of hierarchically arranged queues includes partitioning said jitter buffer memory into said queues by using powers of 2 division factors.
